(19) United States
(12) Patent Application Publication
(10) Pub. No.: US 2011/0249429 A1
(43) Pub. Date: Oct. 13, 2011

(54) METHODS AND APPARATUS FOR ATTACHING A VIEWING AID TO A VISUAL CONTENT SOURCE VIA INTERCHANGEABLE FASTENERS

(75) Inventors: James F. Bennett, JR., Nantucket, MA (US); Wa-Ming Law, Yuen Long (HK)

(73) Assignee: LightWedge LLC

(21) Appl. No.: 13/046,366

(22) Filed: Mar. 11, 2011

Related U.S. Application Data
(60) Provisional application No. 61/313,606, filed on Mar. 12, 2010.

(51) Int. Cl. F21L 4/04; F21V 19/02; F21L 4/08; F21V 19/00

(52) U.S. Cl. 362/183; 362/382; 362/430; 362/427; 362/191

(57) ABSTRACT

Disclosed herein are viewing kits that can be assembled and coupled to visual content sources, such as e-readers, to facilitate viewing visual content. Example viewing kits include a viewing aid, which may include a light, lens, filter, or other implement, and an interchangeable fastener that can be removably coupled to the viewing aid using a slot-and-key interface or other suitable coupling mechanism. Either the fastener alone, or the fastener coupled together with the viewing aid, provides a deformable cavity that is shaped to clamp onto an edge of the e-reader. Inserting the e-reader into the cavity causes the fastener, which is made of resilient material, to bend outwards. In response, the fastener exerts a pinching force on the e-reader, creating a pressure fit that connects the viewing aid securely to the e-reader.

### CROSS-REFERENCE TO RELATED PATENT APPLICATIONS

The present application claims the benefit, under 35 U.S.C. §119(e), of U.S. Provisional Application Ser. No. 61/313,606, filed Mar. 12, 2010, entitled “Methods and Apparatus for Attaching a Functional Element to a Substrate with Interchangeable Fasteners,” which application is incorporated herein by reference in its entirety.

### BACKGROUND

Booklights are lighting devices designed to be attached or affixed to a book. Conventional booklights are generally small, light-weight, and battery-powered, which allows them to be easily carried along with a book to facilitate reading in locations where ambient light may be insufficient or unavailable. Booklights may include various types of light sources (e.g., small incandescent light bulbs, light-emitting diodes, etc.) and are typically equipped with a small mechanical clasp that engages (e.g., grips or pinches) a cover and/or one or more pages of a book to affix the booklight to the book. Because the clasp generally is configured to accommodate a range of thicknesses common to book covers and/or pages, booklights generally are designed as a fixed, single unit with the clasp irremovably (fixedly) coupled to the light source.

### SUMMARY

Applicants have recognized and appreciated that small lighting devices such as booklights may be useful for facilitating reading and perception of visual content from a variety of sources in addition to conventional books or other sources of printed media. However, the small clasp generally found on conventional booklights may in some instances limit the type of visual content source to which the booklight may be affixed. For example, a conventional booklight might not be easily affixed to the body of a laptop computer so as to illuminate a keyboard and/or display of the computer, as the clasp of a booklight may not be large enough to grip the body of the laptop computer.

In particular, Applicants have recognized and appreciated that viewing aids, such as booklights, may have advantageous uses in connection with electronic reading devices (“e-readers”) for displaying electronic books (“e-books”). E-readers offered by different manufacturers/vendors come in a variety of shapes and sizes, many of which have dimensions that are not necessarily well-suited to the small clasp typically found on conventional booklights. Given the diversity of e-reader product offerings, a typical booklight clasp may not be appropriately configured and/or dimensioned to accommodate different e-readers, and so lighting devices to attach to e-readers may need to be particularly configured for a given type of e-reader (e.g., an owner of an e-reader may need to buy a custom lighting device particularly designed to match the e-reader, and this lighting device may not be useable on other e-readers). From a manufacturing and sales standpoint, the need to manufacture and/or offer for sale a line of customized lighting devices to accommodate different e-reader products may not necessarily provide the most cost-effective and/or profitable solution.

More generally, Applicants have also appreciated that, given the various types of visual content sources available to consumers, a variety of functional elements may be employed as viewing aids to facilitate reading or perception of the visual content (e.g., lighting devices, optics such as magnifiers, filters, or prescription viewing optics, shading devices, etc.). Given that such functional elements may be employed similarly with various types of visual content sources, Applicants have recognized that it would be convenient to allow a given functional element to be flexibly utilized with (e.g., attached to) visual content sources of different shapes, dimensions, styles and form factors.

In view of the foregoing, described herein are viewing aids, including lighting devices, that may affix to and be used with objects such as visual content sources, of different shapes and different sizes, to facilitate viewing of visual information provided by such objects.

Embodiments of the inventive subject matter include kits (e.g., unassembled parts sold together in a package) that include a viewing aid, such as a booklight, magnifier, filter, or prescription lens, and an interchangeable fastener that can be removably coupled to the viewing aid. The fastener or, when coupled, the viewing aid and fastener form an assembly with a deformable cavity that facilitates a mechanical coupling of the viewing aid to a visual content source (e.g., an e-reader). In some kits, the cavity is formed by the viewing aid and the fastener, when coupled, is a deformable cavity that facilitates a pressure-fit coupling, via a pinching force, of the viewing aid to the visual content source. In other kits, the cavity is formed by the fastener alone and provides a similar pressure-fit coupling of the viewing aid to the visual content source.

Example kits may also include the visual content source itself. Some exemplary kits are designed specifically to accommodate e-readers and other similar visual content sources. In these cases, the viewing aid may include a lighting device (e.g., an incandescent bulb and/or light-emitting diode), a filter, a magnifying lens, and/or a prescription lens.

Exemplary fasteners can be at least partially made of a resilient material, such as plastic, that deforms upon insertion of the visual content source into the deformable cavity. When deformed by insertion of the visual content source into the deformable cavity, such an exemplary fastener exerts a normal force on the visual content source. Exemplary fasteners and/or viewing aids may also include a pad or textured surface which, when the viewing aid is coupled to the fastener, is disposed along an inner surface of the cavity so as to facilitate the mechanical coupling of the viewing aid to the visual content source.

Inventive fasteners and viewing aids may formed in any one of a number of ways. For example, inventive viewing aids may include a body portion (e.g. a housing) and a first coupling interface formed on, or attached to, the body portion. Complementary inventive fasteners may include a second coupling interface to mechanically couple to the first coupling interface of the viewing aid so as to facilitate mechanical coupling and decoupling of the fastener and the viewing aid.

The first and second coupling interfaces may include complimentary mating interfaces, such as “slot and key” interfaces, i.e., where the first coupling includes one of a slot and a projecting member that fits into the slot; and the second coupling interface includes the other of the slot and the projecting member. Such slot-and-key interfaces may also include a locking mechanism in which one of the slot and the projecting member includes a locking tab to facilitate locking engagement between the slot and the projecting member. In these embodiments, the other of the slot and the projecting member can include an optional depression to receive the locking tab.

In example implementations of the inventive kit, the first coupling interface includes a projecting member formed on or attached to the body portion of the viewing aid and the second coupling interface includes a slot in at least a portion of the fastener configured to receive the projecting member. In these example kits, the second coupling interface is formed of a resilient material that deforms upon insertion of the projecting member into the slot, such that the second coupling interface exerts a pinching force on the projecting member to facilitate mechanical coupling of the fastener and the viewing aid. The projecting member may also include at least one locking tab to facilitate locking engagement between the slot and the projecting member, and the slot includes at least one depression to receive the at least one locking tab.

Some inventive kits have viewing aids that include a lighting device, which in turn includes an arm coupled to a body portion of the viewing aid and at least one light source disposed in or on the arm. In these inventive kits, the arm is movable with respect to the body portion between a stowed position substantially adjacent to the body portion and a deployed position. The light source(s) may be activated to generate light when the arm is moved to the deployed position, e.g., by an internal or an external switch.

In some of these inventive kits, the arm includes a curved member with a proximal end rotatably coupled to the body portion of the lighting device and a distal end in or on which the at least one light source is disposed. The curved member is configured to rotate from the stowed position to the deployed position. Rotating the curved member from the stowed position to the deployed position may automatically activate the light. An optional cam housed within the body portion and coupled to arm limits a rotation range of the curved member.

In other inventive kits with an arm, the arm of the lighting device includes a flexible member. When in the stowed position, the flexible member is wrapped around at least a portion of a perimeter of the body portion of the lighting device. Example flexible members can be articulated when deployed.

Alternative inventive kits may include a booklight and interchangeable first and second fasteners for securing the booklight to visual content sources of different sizes and shapes. Booklights may include a body portion (housing), an arm rotatably coupled to the body portion, and at least one light source on or in the arm along with a first interface to facilitate mechanical coupling of the booklight to one of many different interchangeable fasteners. These alternative kits also include a first fastener and a second fastener, each of which includes an interface to mechanically couple to the first interface of the booklight so as to facilitate mechanical coupling and decoupling with the booklight. The booklight can be mechanically coupled to either the first fastener or the second fastener to form an assembled kit with a deformable cavity that facilitates pressure-fit coupling, via a pinching force, of the booklight to edges of different e-readers. In some cases, the booklight and fastener form the cavity; in other cases, the fastener alone defines the cavity. The size and shape of the cavity may depend on the size and shape of the particular fastener coupled to the booklight and may be selected based on a given e-reader's physical characteristics, such as edge shape or thickness.

Still other inventive embodiments include a booklight having an arm (e.g., rotatable or flexible) with a light disposed in/on one end of the arm and a body portion to which the arm is coupled. The body portion of the booklight also includes a coupling interface to mate with multiple interchangeable fasteners to facilitate mounting the booklight to an e-reader. The arm is movable with respect to the body portion between a stowed position substantially adjacent to the body portion and at least one deployed position. Moving (rotating) the arm to the deployed position activates the light source via a switch disposed within the body portion that couples the light source to a power source disposed within the body portion. In some embodiments, the power source includes a rechargeable battery and the booklight includes a power interface disposed on the body portion or the coupling interface to receive external power to recharge the rechargeable battery.

In some inventive booklights, the arm includes a curved member with a proximal end rotatably coupled to the body portion (e.g., via a hinge disposed within the body) and a distal end that holds or otherwise supports the light source. The curved member is configured to rotate from the stowed position to the deployed position. An optional cam inside the body portion (and possibly coupled to the hinge) limits a rotation range of the arm.

In other inventive booklights, the arm includes a flexible member, which, when in the stowed position, is wrapped around at least a portion of a perimeter of the body portion. The flexible member may be articulated or otherwise adjustable to permit optimal viewing of the visual content.

As stated above, inventive booklights may be removably coupled to a fastener, forming a deformable cavity that facilitates a pressure-fit coupling, via a pinching force, of the booklight and the fastener to an edge of an e-reader or other visual content source. An optional pad or textured surface disposed on the body portion of booklight is disposed along an inner surface of the deformable cavity when the booklight is coupled to the fastener.

Inventive subject matter also includes methods of assembling a viewing aid and a fastener to form a cavity, and attaching the assembled viewing and fastener to a visual content source. First, a user mechanically engages a first coupling interface of a viewing aid to a second coupling interface of a fastener to form a cavity. Alternatively, the fastener alone may define the cavity. Next, the user inserts the visual content source at least partially into the cavity. Once the visual content source is at least partially in the cavity, the user positions the viewing aid to facilitate viewing of at least some of the visual content, e.g., by moving an arm of the viewing aid from a stowed position to a deployed position such that a light source in or on the arm illuminates at least part of the visual content. In some examples, the user rotates the arm from the stowed position to the deployed position. In other examples, the user unwraps a flexible member that forms at least part of the arm from around a housing of the viewing aid.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter appearing as numbered concepts at the end of this disclosure are contemplated as being part of the inventive subject matter disclosed herein.

### BRIEF DESCRIPTION OF THE DRAWINGS

The skilled artisan will understand that the figures, described herein, are for illustration purposes only, and that the drawings are not intended to limit the scope of the disclosed teachings in any way. In some instances, various aspects or features may be shown exaggerated or enlarged to facilitate an understanding of the inventive concepts disclosed herein (the drawings are not necessarily to scale, emphasis instead being placed upon illustrating the principles of the teachings). In the drawings, like reference characters generally refer to like features, functionally similar and/or structurally similar elements throughout the various figures

FIGS. 1A-1D are various perspectives views of an assembled viewing kit, which includes a viewing aid mechanically coupled to a fastener, which assembly in turn is coupled to an e-reader to facilitate viewing of visual content on the e-reader, according to one embodiment of the present invention.

FIG. 2A illustrates how the viewing aid and the fastener of FIGS. 1A-1D are coupled and decoupled to facilitate use of interchangeable fasteners with the viewing aid to accommodate different types of e-readers, according to one embodiment of the present invention.

FIG. 2B illustrates an example of a mating coupling interface for the viewing aid and the fastener, according to one embodiment of the present invention.

FIG. 2C illustrates the viewing aid of FIGS. 1A-1D coupled to an alternative fastener, according to one embodiment of the present invention.

FIGS. 3A-3C illustrate perspective views of the viewing aid and fastener of FIGS. 1A-1D with the viewing aid in a stowed position, according to one embodiment of the present invention.

FIG. 4 is a perspective view of the viewing aid and the fastener of FIGS. 1A-1D with the viewing aid in a deployed position, according to one embodiment of the present invention.

FIGS. 5A-5B illustrate internal components of the viewing aid, according to one embodiment of the present invention.

FIG. 6A-6C are perspective views of an alternative viewing aid and fastener in stowed and deployed positions, according to one embodiment of the present invention.

FIG. 6D is a perspective view of viewing aid and one or more fasteners, according to another embodiment of the present invention.

FIG. 7 shows a flowchart of one technique for using a viewing aid and a fastener, according to one embodiment of the present invention.

FIG. 8 shows a flowchart of another technique for using a viewing aid and a fastener, according to one embodiment of the present invention.

FIG. 9 shows a flowchart of a technique for using a viewing aid and a set of two or more fasteners, according to one embodiment of the present invention.

FIG. 10 shows an example of another technique for using a viewing aid and a set of two or more fasteners, according to one embodiment of the present invention.

FIG. 11 shows a flowchart of one technique for making a fastener having dimensions that correspond to dimensions of an edge of a particular substrate, such that the fastener may be affixed to the edge of the particular substrate, according to one embodiment of the present invention.

FIG. 12 shows a flowchart of one technique for making a fastener having dimensions that correspond to dimensions of an edge of a particular substrate, such that the fastener may be affixed to the edge of the particular substrate, according to one embodiment of the present invention.

### DETAILED DESCRIPTION

Following below are more detailed descriptions of various concepts related to, and embodiments of, inventive methods and apparatus for attaching various functional elements (e.g., a viewing aid) to a visual content source (e.g., an e-reader) via interchangeable fasteners. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As discussed above, in some embodiments a viewing aid may be provided with a first interface and a fastener may be provided with a second interface that is complementary to the first interface. The first and second interfaces are adapted to engage one another to removably couple the viewing aid to the fastener (i.e., facilitate coupling and decoupling of the viewing aid and the fastener). In some embodiments, multiple different fasteners may be provided with interfaces complementary to the first interface of the viewing aid, such that the viewing aid may be removably coupled to each of multiple fasteners. Additionally or alternatively, in some embodiments multiple viewing aids may be provided with interfaces complementary to the second interface of the fastener, such that the fastener may be removably coupled to each of multiple viewing aids. In some such embodiments, viewing aids may be coupled to only one fastener at a time, and fasteners may be coupled to only one viewing aid at a time.

As exemplary non-limiting embodiments of the inventive concepts herein, an assembly including a viewing aid and a fastener to be removably coupled to the viewing aid may be implemented as a Verso® Arc Light or a Verso® Wrap Light available from LightWedge® LLC of Newton, Mass. Examples of sources of visual information include, but are not limited to, electronic devices such as e-readers (e.g., the Amazon Kindle, the Amazon Kindle DX, the Sony Reader, the Barnes and Noble Nook), tablet computers, laptop computers, portable movie players, and portable game devices, and non-electronic devices such as books, clipboards, and binders.

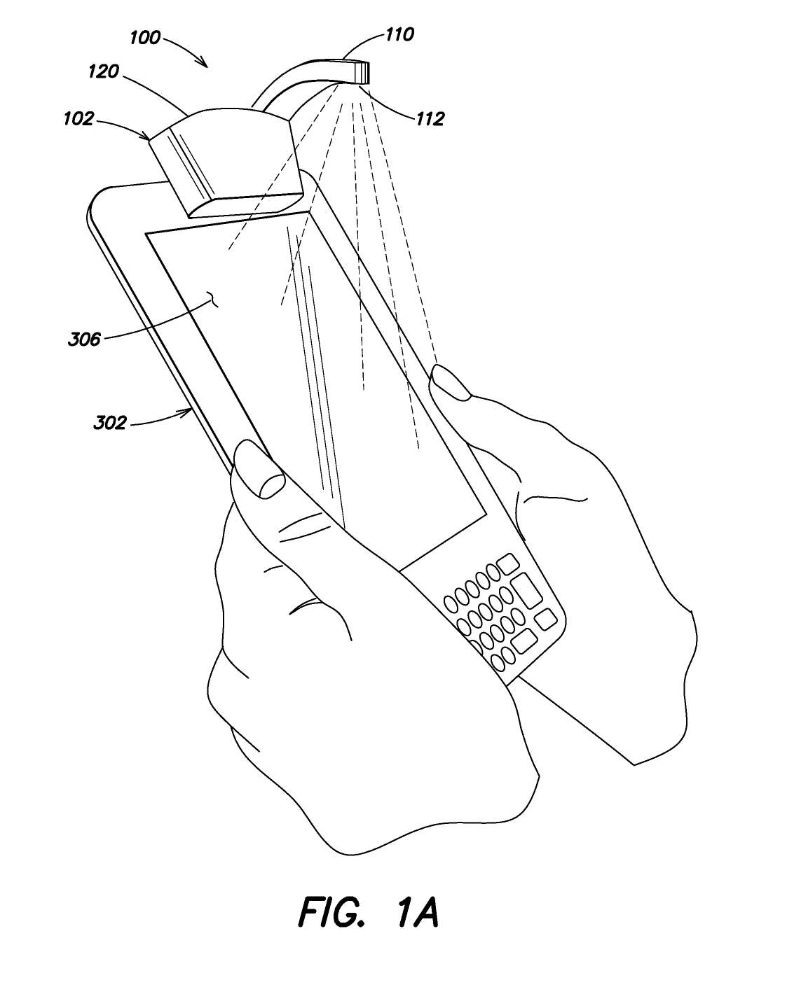

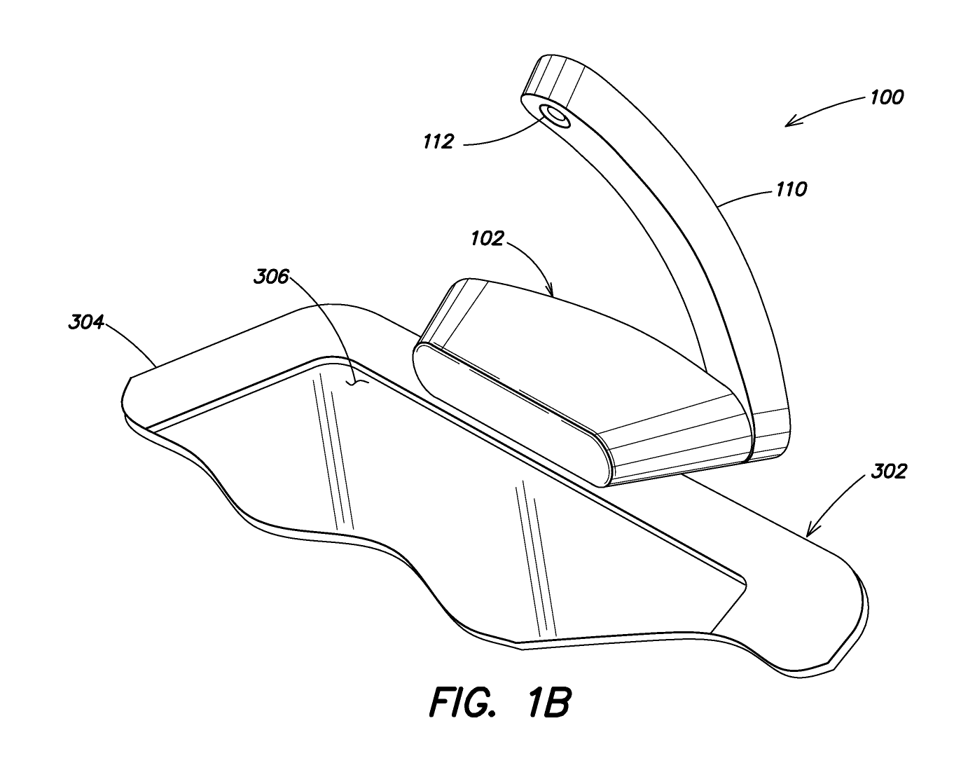

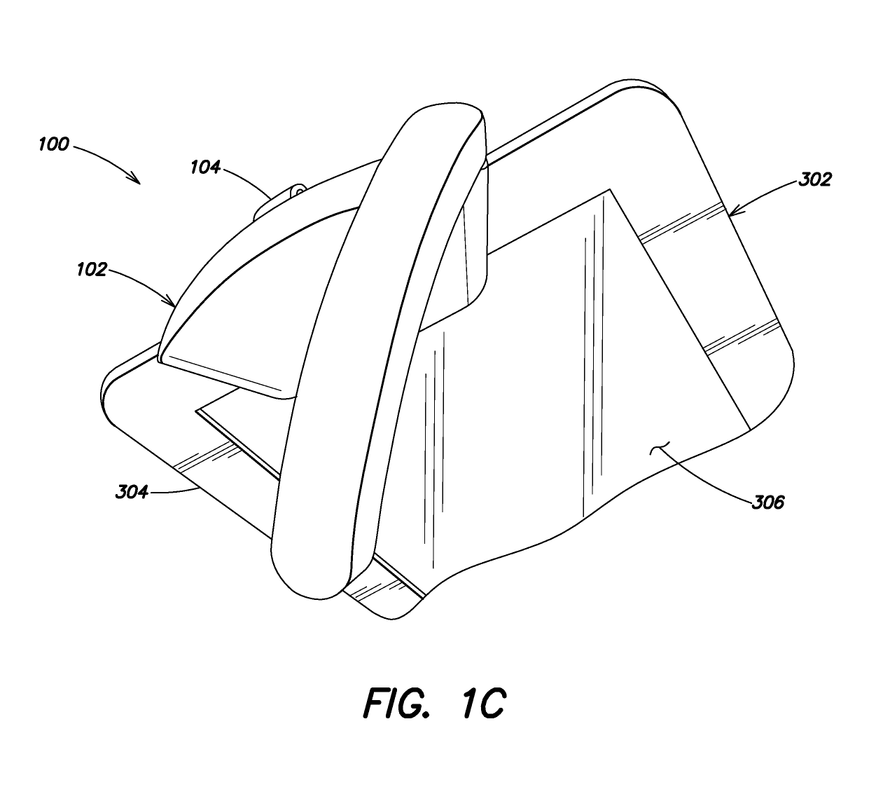

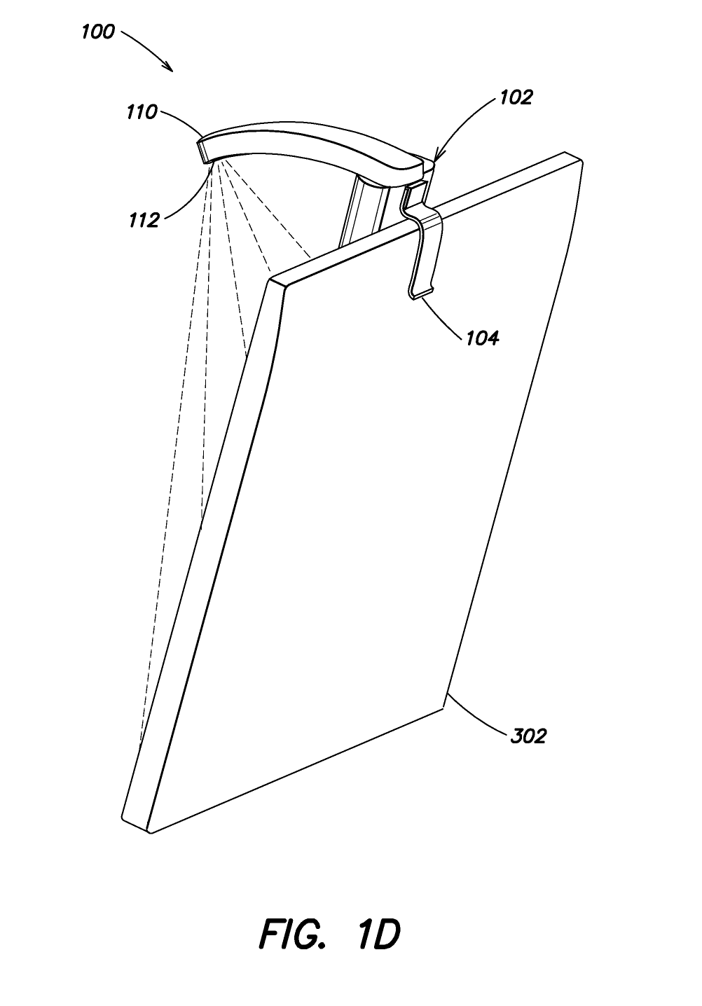

FIGS. 1A-1D show an assembled kit 100 that facilitates viewing of visual content, such as text or pictures, displayed via a substrate or other visual content source—in this case, an e-reader 302. The kit 100 includes a viewing aid 102 and a fastener (described below) that are coupled together and secured to the e-reader 302. The user deploys the assembled viewing kit 100 by swinging a curved arm 110 into position above the visual content shown on the e-reader's screen 306. A light 112 at one end of the curved arm illuminates at least some of the visual content, making it easier for the user to read the visual content. In alternative embodiments, the curved arm 110 may hold a magnifier instead of or in addition to the light 112 to magnify the visual content.

A fastener 104 may be implemented in any suitable manner to affix to an edge 304 of the substrate (e-reader 302). In some embodiments, a fastener 104 may affix to the edge 304 such that the fastener 104 does not separate from the substrate due to the force of gravity or the force of being casually lifted or carried by a person, but may be separated due to application of force by a person to pull the fastener 104 away from the substrate or a force greater than that applied when being casually lifted or carried (e.g., the force of being swung). In some embodiments, the fastener 104 may be affixed to the substrate such that the fastener 104 only separates from the substrate when a user operates the fastener 104 to separate the fastener 104 from the substrate.

In some such embodiments, the fastener 104 may be held to the substrate by frictional force due to a friction between the fastener 104 and the substrate when the fastener 104 is affixed to the substrate. In other such embodiments, in addition to or as an alternative to frictional force, the fastener 104 may be held to the substrate by a force applied by mechanical pinching. The force of mechanical pinching may be created when affixing the fastener 104 to the substrate results in deformation of the fastener 104, and the fastener 104 is made of a material resilient to deformation. When fastener 104 resists the deformation, the force of mechanical pinching may be applied to the substrate to hold the fastener 104 onto the substrate. One example of a material that is resilient to deformation is hard plastic.

Dimensions of a fastener 104, including a shape and size of the fastener 104, may be based on dimensions of an edge of a particular substrate, such that the fastener 104 is able to affix to the particular substrate. As discussed above, for each substrate, a different fastener 104 may be created having dimensions that correspond to the particular substrate. If, however, two or more substrates have dimensions that are equal or similar, a fastener 104 may be used with the two or more substrates.

A fastener 104 may, in some cases, include two components: a curve that has a size and shape based on an edge of the substrate and members that extend away from the curve of the fastener 104 and have a size and shape based on a size and shape of faces of the substrate.

For example, if the edge of the substrate is a perfect circle, then the fastener 104 may be shaped as a curve that is a circular or approximately circular to correspond to the edge of the substrate. Where the edge of the substrate is a section of an oval, then the fastener 104 may be shaped as a curve that is ovoid to correspond to the edge of the substrate. Similarly, where the edge of the substrate includes a squared off or a rounded corner, the fastener may be shaped as a curve that is a squared off or a rounded corner to correspond to the shape of the edge of the substrate. A fastener 104 may be implemented having any suitable shape to correspond to any suitable shape of the edge 304 of a substrate 302.

Additionally, a size of the fastener 104 may be based on a size of the edge of the substrate, such that the fastener 104 is able to affix to the substrate. For example, an internal dimension of a curve of the fastener 104 may be equal or approximately equal to an external dimension of the edge of the substrate, such that the internal curve of the fastener 104 is able to contact the edge of the substrate. For example, a width of a space created by the curve may be equal or approximately equal to a thickness of the edge of the substrate. In some embodiments, the size of the internal dimension of the curve may be slightly smaller than an external dimension of the edge of the substrate. In some such embodiments, the fastener 104 may be made of a material resilient to deformation, and when the fastener 104 is affixed to the substrate, the fastener 104 may deform slightly and causes the fastener 104 to mechanically pinch the substrate.

In addition to a curve corresponding to a shape of an edge 304 of a substrate, a fastener 104 may include members that extend beyond an edge 304 of the substrate when the fastener 104 is affixed to the substrate. The members of the fastener 104 may act to stabilize the fastener 104 on the substrate. The dimensions of the members, including a shape and size of the members, may be based on the dimensions of the faces of the substrate that meet at the edge of the substrate.

For example, if a face of the substrate is a frame or bezel surrounding a source of visual information, then a length of a member of the fastener 104 may be smaller than a width of the frame or bezel to prevent the member from extending into the source of visual information. Some fasteners 104 that are adapted to affix to the substrate may include members have a length that is less than a width of the bezel to prevent the members from extending into the area of the screen and obstructing view of the screen.

A shape of the members of the fastener 104 may also be based on a shape of a face or faces of the substrate. For example, if a face of a substrate curves as face moves away from the edge, the member of the fastener 104 may have a curve that corresponds to the curve of the face.

In some embodiments, the fastener 104 may be adapted to be affixed to a substrate alone. In such embodiments, a fastener 104 may be adapted to affix to a substrate without being removably coupled to a viewing aid 102. In some such embodiments, the fastener 104 may be implemented as approximately a C-shape—including a semi-circle, approximately a semi-circle, or other shape corresponding to a shape of an edge and/or face of a substrate—that is able to fit around an edge of a substrate.

In some embodiments, a fastener 104 may not have a shape that corresponds to a shape of an edge of a substrate, but may have a size that corresponds to a shape of an edge of a substrate. For example, each of multiple fasteners 104 may be implemented having a common shape that roughly approximates a shape of an edge of a substrate, such as a C-shape. Each of the multiple fasteners 104, though, may have a size that corresponds to a size of a particular substrate, such that a fastener 104 may be customized to affix to the edge of the particular substrate. As discussed above, the size of the fastener 104 may be equal or approximately equal to a size of the edge of the particular substrate. For example, a width of a space of the fastener (e.g., a width of a space of a C-shape) may be equal or approximately equal to a thickness of the particular substrate.

In other embodiments, a fastener 104 may be adapted to affix to a substrate when the fastener 104 is removably coupled to a viewing aid 102. This may be the case, for example, where the fastener 104 is implemented as a half (e.g., a top half or bottom half) of a C-shape, having a size and shape corresponding to a size and shape of a portion of an edge of a substrate. In such embodiments, a viewing aid may form another part of the fastener 104, such as a complementary part of a C-shape. When the fastener 104 is removably coupled to the viewing aid 102 to form an assembly 100, the assembly 100 may form a C-shape. One embodiment of a fastener 104 that is adapted to affix to a substrate when the fastener 104 is removably coupled to a viewing aid 102 is shown in FIGS. 1A-1D, wherein the fastener 104 has a shape similar to a bottom half of a C-shape. When the fastener 104 of FIGS. 1A-1D is removably coupled to the viewing aid 102, a space created between the fastener 104 and the viewing aid 102 is substantially C-shaped and may approximate dimensions of an edge of a substrate.

In some embodiments where a fastener 104 is adapted to affix to a substrate when removably coupled to a viewing aid 102, a fastener 104 may have a size and shape corresponding to the edge of a particular substrate, but a viewing aid 102 may have a size and shape that does not correspond to the particular substrate. This may be because the fastener 104 is designed for a particular substrate, but the viewing aid 102 is designed to operate with multiple different substrates. In other embodiments, though, the viewing aid 102 may have a size and shape based on the size and shape of the edge of the substrate or roughly approximating a size and shape of an edge of the substrate.

In one embodiment, for example, an assembly may include a viewing aid that is a lighting device and a fastener removably coupled to the viewing aid. In this embodiment, the fastener may be adapted to affix to a substrate when removably coupled to the viewing aid and not alone. The fastener may have a shape roughly corresponding to a bottom half of a C-shape. In this embodiment, the fastener may be adapted to affix the assembly to an Amazon Kindle 2 e-reader, available from Amazon.com, Inc., of Seattle, Wash. A thickness of an edge of the Amazon Kindle 2 e-reader is 9.2 mm. When the fastener is removably coupled to the viewing aid, a space may be created between one part of the fastener and a housing of the viewing aid that is equal to, or slightly less than, 9.2 mm. For example, the space may be between 8.5 mm and 9.2 mm, including 9 mm. This may be done so that when the Amazon Kindle 2 e-reader is inserted into the space between the fastener and the housing of the viewing aid, the fastener is deformed slightly. The fastener may include a material that is resilient to deformation, and when deformed may resist the deformation and attempt to return to its normal shape. When the fastener resists the deformation, the fastener may mechanically pinch the Amazon Kindle 2 e-reader so that the fastener holds the assembly to the Amazon Kindle 2 e-reader and affixes the assembly to the Amazon Kindle 2 e-reader.

A viewing aid 102 may be any device that facilitates viewing of visual information. Viewing of visual information may be facilitated in various ways. For example, illuminating a source of visual information may facilitate viewing the visual information. This may be the case, for example, where there is little ambient light to enable the visual information to be viewed using the ambient light. As another example, removing light or certain types of light may facilitate viewing the visual information. This may be the case, for example, where there is too much ambient light to permit the visual information to be easily viewed, where too much light is being reflected or generated by the source of visual information to permit the visual information to be easily viewed, where a color of the ambient light is affecting easy viewing of the visual information, or where a color of light reflected or generated by the source of visual information is affecting easy viewing of the visual information. As another example, if the visual information is small, magnifying the visual information may facilitate viewing of the visual information. As another example, if a particular person has a visual difficulty, such as far-sightedness, near-sightedness, or color blindness, adjusting the light leaving the source of visual information to compensate for the visual difficulty may facilitate viewing of the visual information.

The examples of viewing aids described above are “optically-interactive” devices that affect light leaving the source of visual information by adding light, removing light, or changing light. Viewing aids are not limited to being optically-interactive devices, however. As another example of a viewing aid, viewing visual information may be facilitated by placing the visual information in context, through addition of another source of second visual information having content related to the original visual information. An example of second visual information to facilitate viewing of original visual information may be a transparent or partially-transparent overlay through which the original visual information can be seen in tandem with the second visual information. Another example of a second source of visual information may be placed next to the first source of original visual information. Facilitating the viewing of visual information may include preserving or protecting a source of the visual information, and so another example of a viewing aid may be a protective sheet or panel that is placed above the source of visual information.

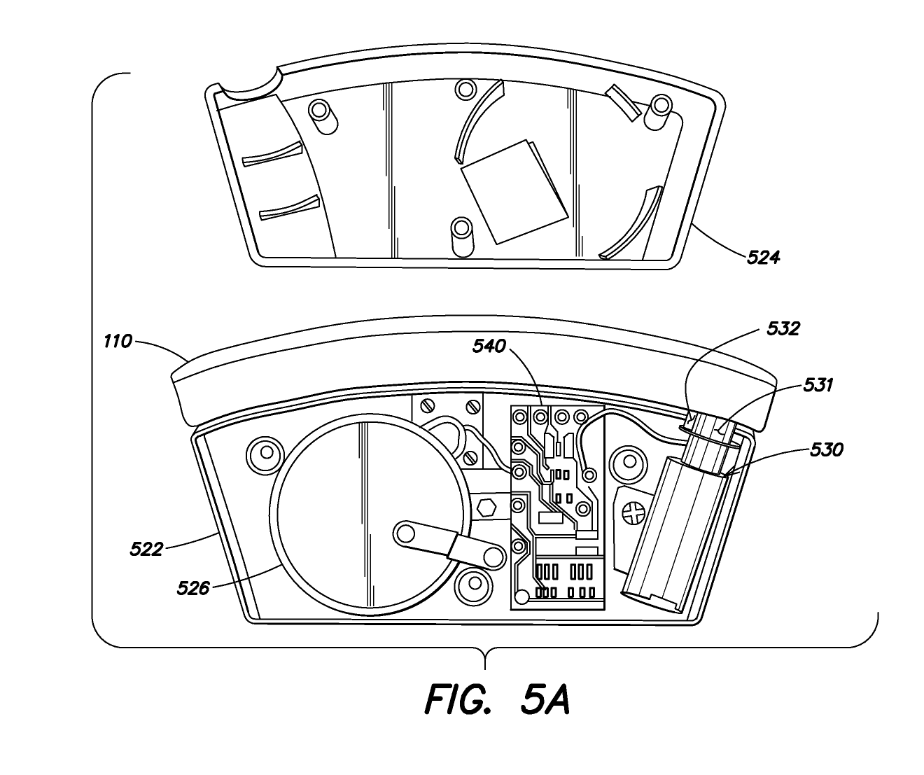

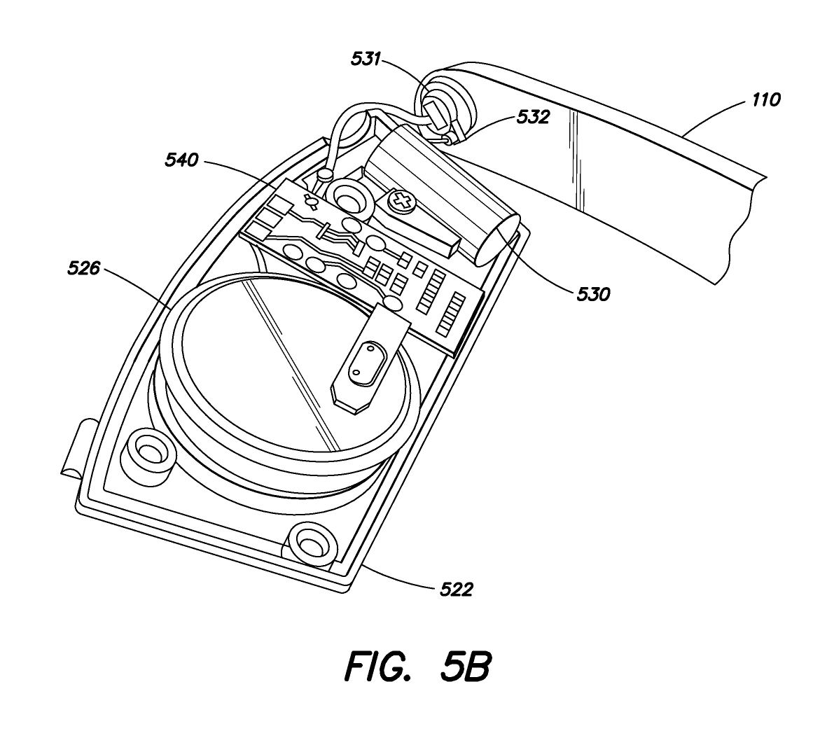

In some implementations, a viewing aid 102 may be an electronic device that may be powered from any suitable source of power. In some cases, a viewing aid 102 may be powered by a battery, including a rechargeable battery, disposed within a body portion or housing 120 (as discussed further below in connection with FIGS. 5A and 5B). In embodiments where a viewing aid 102 includes a rechargeable battery, the rechargeable battery may be removable to be recharged and/or may be rechargeable within the viewing aid 102 using recharging circuitry of the viewing aid 102. In embodiments where the viewing aid 102 includes recharging circuitry, the recharging circuitry may receive outside power using any suitable power interface. In some implementations, the interface may be a power interface related to a power interface of a substrate to which the viewing aid 102 may be attached. For example, if a substrate to which the viewing aid 102 may be attached includes a capability to output power using a particular power interface, the viewing aid 102 may include a power interface to receive power using the particular power interface of the substrate. In one implementation, the power interface of the viewing aid 102 is a Universal Serial Bus (USB) interface, but embodiments are not limited to using any particular power interface.

Any suitable device that facilitates viewing of visual information may be implemented as a viewing aid.

Accordingly, in some embodiments, a viewing aid may include a lighting device that produces light (e.g., white light, colored light, etc.) from any suitable light source (e.g., incandescent bulb, light-emitting diode, etc.). In other embodiments, a viewing aid may include a passive or active filter that subtracts some light leaving a source of visual information. In other embodiments, a viewing aid may include a magnifying lens, a prescription lens, or any other lens that adjusts a light leaving a source of visual information. In some embodiments, a viewing aid may facilitate the viewing of visual information in multiple ways, such as through including a lighting device and a magnifying lens. Any suitable viewing aid that facilitates the viewing of visual information in any suitable manner may be used in embodiments.

As discussed above, a substrate to which the assembled viewing kit 100 may be affixed may be a source of visual information. A source of visual information may be electronic or non-electronic. A source of visual information may present static or dynamic visual information. In some cases, a source of visual information may not include a light source and/or may not generate light. In other cases, a source of visual information may include different parts presenting visual information, and some of these parts may generate light and others may not generate light. For example, a source of visual information may include a first display (displaying visual information) that generates light to present visual information and a second display (also displaying visual information) that does not generate light to present visual information. As another example, a source of visual information may include an input device (e.g., a keyboard) that does not generate light and a display that does generate light to present visual information.

Sources of visual information may present any suitable visual information. Some sources of visual information may present visual information that does not change, while other sources of visual information may change a visual information that is presented or change a manner in which visual information is presented (e.g., change a color or size of the visual information). A source of visual information may present different types of visual information, including presenting different types of visual information at a same time or at different times. Examples of types of visual information include text, pictures, graphics, animations, and videos. Additionally, any symbols having a meaning and that are capable of being viewed (e.g., by a human or electronic device) may be presented as visual information by a source of visual information.

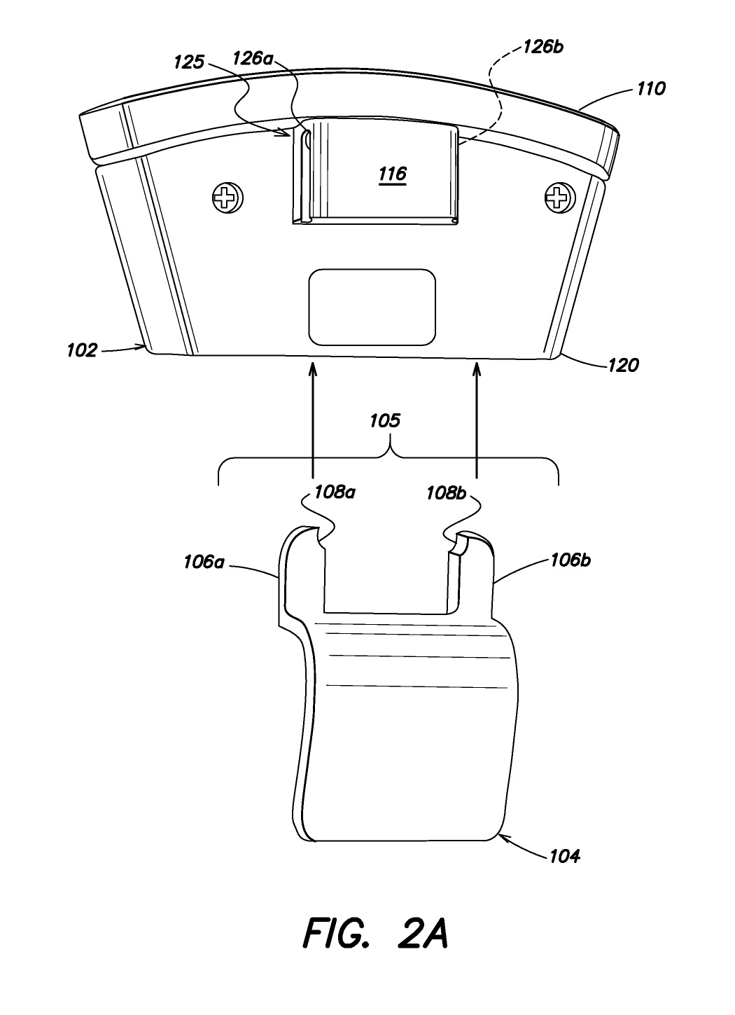

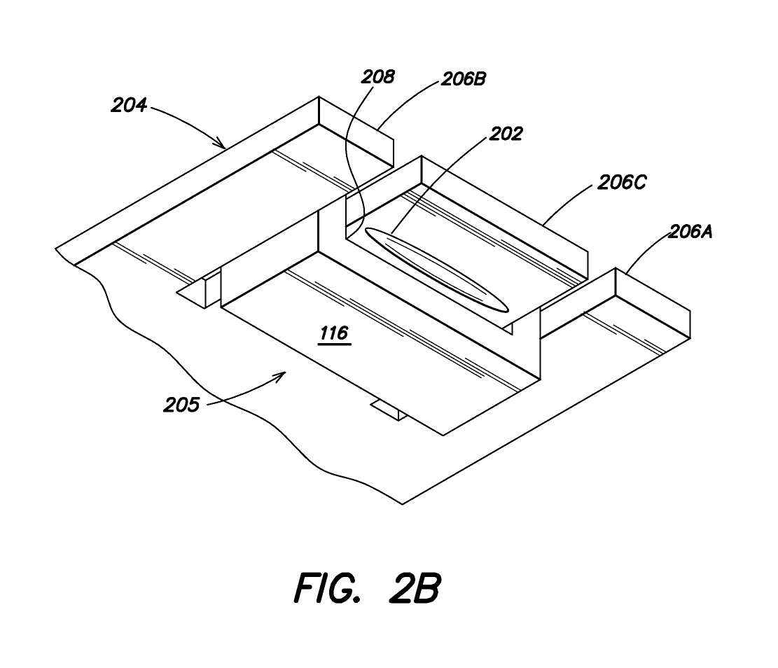

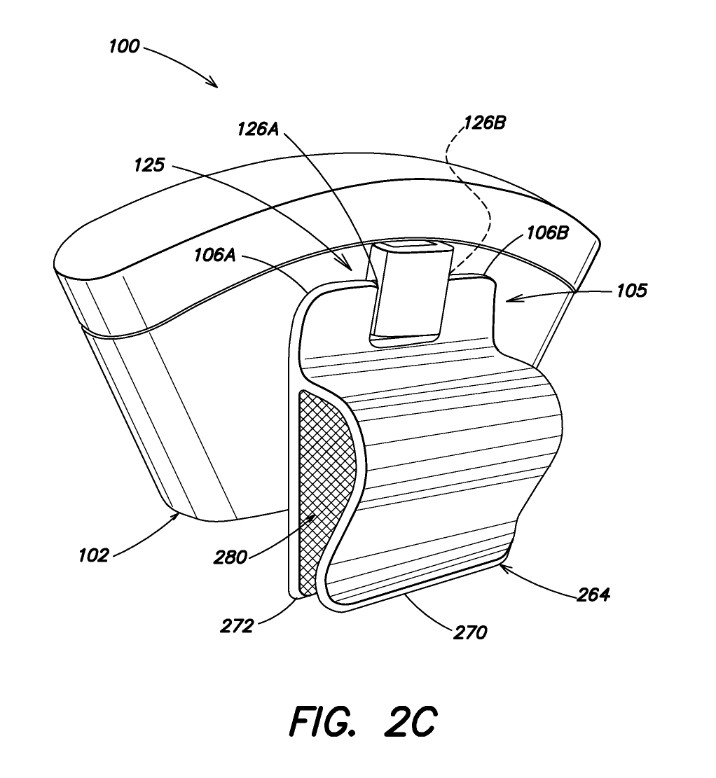

FIG. 2A illustrates one technique for assembling the kit 100 of FIGS. 1A-1D. The viewing aid 102 is removably coupled to an interchangeable fastener 104, which is made of a resilient material, such as plastic, via a slot-and-key interface to form the assembled viewing kit 100. The fastener 104 may be of a size and shape to affix the assembled kit 100 to an edge of a particular substrate (e.g., the e-reader 300 shown in FIG. 1A-1D). The fastener 104 may affix to the edge of the particular substrate in any suitable manner, including by exercising a pinching force on the edge. In one exemplary implementation, discussed in greater detail below, the fastener 104 may be made of a material that is resistant to deformation, and may exert the pinching force on the edge when the edge of the substrate deforms the fastener 104. Examples of viewing aids 102, fasteners 104, substrates, and visual information are discussed in greater detail below.

As shown in FIG. 2A, the fastener 104 includes a key interface 105 with a pair of projecting members 106a and 106b that form the “keys” in the slot-and-key joint that connects the fastener 104 to the lower surface of the viewing aid's housing 120. The housing 120 includes a slot interface 125 that includes slots 126a and 126b formed as part of the housing 120. Inserting the projecting members 106a and 106b into slots 126a and 126b, respectively, on either side of a band 106 that extends from the housing 120 connects the fastener 104 to the viewing aid 102, forming a concavity (described below) between the viewing aid 102 and the fastener 104. The concavity is suitable for receiving an e-reader, book, or other substrate that displays visual content, as described in greater detail below.

Inserting the projecting members 106a and 106b into the slots 126a and 126b causes the tips of the projecting members 106a and 106b to run up against locking tabs (not shown) recessed within the slots 126a and 126b. Pushing the projecting members 106a and 106b over the locking tabs causes the projecting members 106a and 106b to bend outwards until the locking tabs notch into depressions 108a and 108b in the ends of the projecting members 106a and 106b, forming an interference fit that holds the projecting members 106a and 106b securely within the slots 126a and 126b. Together, the tabs and depressions 108a and 108b act as a locking mechanism that hold the fastener 104 and viewing aid 102 together. To decouple the fastener 104 from the viewing aid 102, the user simply pulls the fastener 104 away from the viewing aid 102 (possibly while wiggling the fastener 104 from side to side).

FIG. 2B shows an alternative slot-and-key coupling mechanism that may be used to connect an alternative fastener 204 to the viewing aid 102. The alternative fastener 204 includes a key interface 205 includes three members 206a, 206b, and 206c extending in parallel from one end of the fastener 204, which is made of resilient material, such as plastic. The central member 206c fits into a slot 208 formed between the band 116 on the bottom of the viewing aid housing 120. Side members 206a and 206b rest along the outer sides of the band 116 and prevent the fastener 204 from rotating too much with respect to the viewing aid 102 as described below.

A locking tab 202 extending from the central member 206c holds the central member 206c in the slot 208. When the member 206c is inserted into the slot 208 from a first side of the band 116, the locking tab 202 may be depressed and forced below the band 116. When the member 206c is fully inserted into the slot 208, the locking tab 202 may lift and contact a second side of the band. The locking tab, by contacting the second side of the band 116, may prevent the member 206c from moving out of the slot 208 and prevent the viewing aid from separating from the fastener. To separate the viewing aid from the fastener, the user deforms (bends) the central member 206c to fit the locking tab 202 under the band 116, then pulls the member 206c out of the slot 208. If the fastener material is sufficiently resilient, the central member 206c may resume its original shape after being fully withdrawn from the slot 208.

As illustrated in FIG. 2B, the key interface 205 may also include members 206a and 206b. When the fastener 204 is coupled to the viewing aid 102, the members 206a and 206b may act to stabilize the connection (joint) by contacting the band 116. The members 206a, 206b may respectively contact the band 206 on outer sides of the band 116. Spaces may be formed between member 206c and member 206a and between member 206c and member 204B, and the size of these spaces may correspond to a thickness of the band 116. When the interfaces are engaged, the band 116 may be inserted into the space. The members 206a, 206b may also contact a housing of a viewing aid to further stabilize the interface.

FIG. 2C shows the viewing aid 102 of FIGS. 1A-1D coupled to an alternative fastener 264 that is interchangeable with the fastener 104 of FIGS. 1A-1D. The alternative fastener 264 includes the same key interface 105 with projecting members 106a and 106b that fit into slots 126a and 126b, respectively, of the slot interface 125 on the viewing aid 102. The alternative fastener 264 also includes a lower member 270 and an upper member 272 that form a cavity 280 to receive a visual content source, such as an e-reader, that is thicker that the thinnest dimension of the cavity 280. Inserting the visual content source into the cavity 280 causes the lower member 270 to bend outwards, expanding the cavity enough to fit the visual content source. The force exerted between the lower member 270 against the visual content source holds the visual content source in the cavity 280. The cavity-facing surfaces of the lower member 270 and/or upper member 272 may also be padded, textured, and/or gnurled to enhance the strength of the mechanical coupling between the fastener 264 and the visual content source.

While FIGS. 2A-2C show different slot-and-key coupling mechanisms and different fasteners, it should be appreciated that slot-and-key coupling mechanisms are merely exemplary of the types of coupling mechanism that may be used. Any suitable coupling mechanism may be used in various embodiments.

Further, it should be appreciated that, for ease of description, the fasteners described above include keys that fits into slots in the viewing aid. In other embodiments, the viewing aids may include keys that fit into slots on the fasteners. Example coupling mechanisms may be formed as integral parts of inventive fasteners and viewing aids (e.g., as part of the viewing aid housing) or attached to inventive fasteners and viewing aids using glue, screws, or any other suitable technique for attaching things together.

Other mechanisms for coupling a viewing aid to a fastener also fall within the scope of the inventive concepts disclosed herein. In general, suitable coupling mechanisms include two interfaces: a first interface on the viewing aid and a second, complementary interface on the fastener designed to engage the first interface. When the interfaces are engaged, they form a coupling mechanism that holds the viewing aid and the fastener together. An optional locking mechanism, such as the locking tabs and depressions described above, may secure the interfaces to each other. In some embodiments, the viewing aid may be removably coupled to the fastener such that the viewing aid does not separate from the fastener due to the force of gravity or the force of being casually lifted or carried by a person, but may be separated due to application of force by a person to pull the viewing aid away from the fastener or application of a force greater than that applied when being casually lifted or carried (e.g., the force of being swung). In some embodiments, the viewing aid may be removably coupled to the fastener such that the device only separates from the fastener when a user operates the interfaces to separate the device from the fastener (e.g., when the user unlocks a locking mechanism).

In some such embodiments, the interfaces may be held together by friction. In other such embodiments, in addition to or as an alternative to a frictional force, the interfaces may be held together by a force applied by pressure fitting, interference fitting, or mechanical pinching. The force of pressure fitting, interference fitting, or pinching may be created when engaging the interfaces results in one of the interfaces deforming the other (or both being deformed) and the interfaces are made of a material resilient to deformation. When one (or both) of the interfaces resist the deformation, the force of pressure fitting, interference fitting, or mechanical pinching may be applied to the other interface.

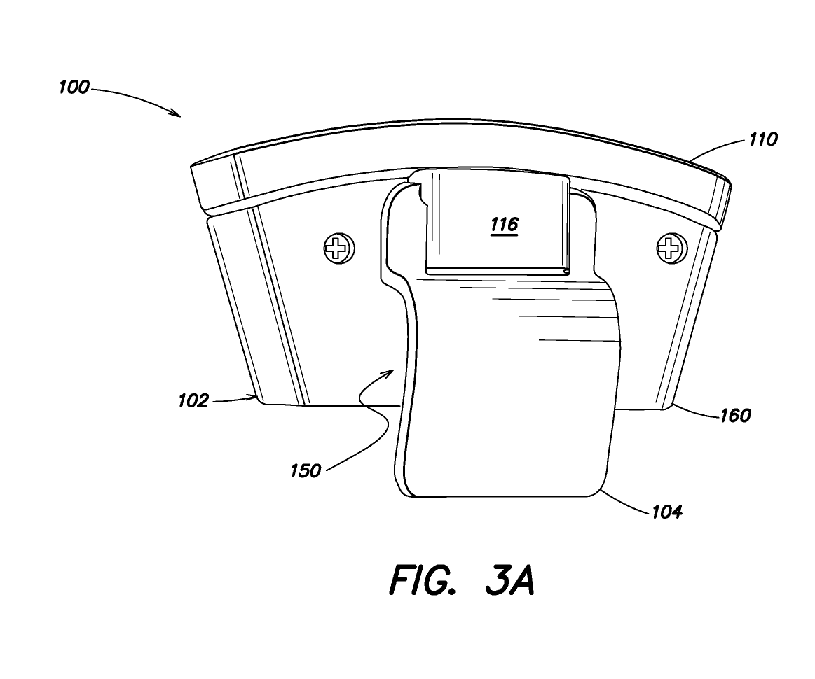

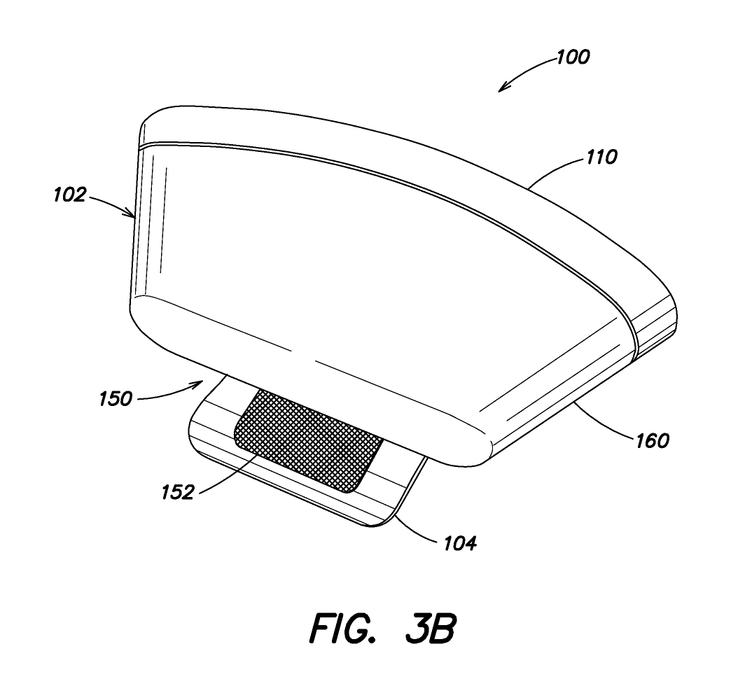

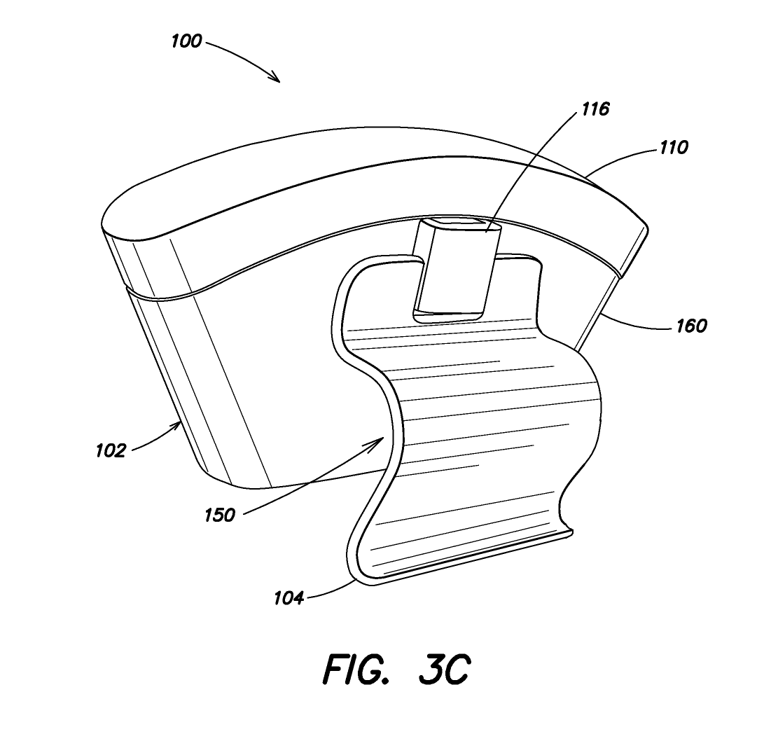

FIGS. 3A-3C are perspective views of the assembled viewing kit 100 that show a cavity 150 that is formed between the viewing aid 102 and the fastener 104 to facilitate a mechanical coupling of the viewing aid 102 to a visual content source. The open edge and/or an interior dimension of the cavity 150 may be slightly smaller than a corresponding dimension of the visual content source such that inserting the visual content source into the cavity 150 causes the fastener 104 to bend, deforming the cavity 150. Because the fastener 104 is resilient, it pushes back against the visual content source, clamping the visual content source within the cavity 150. A pad 152 or textured region disposed along an inner surface of the cavity 150 (e.g., on the viewing aid 102 or, as shown in FIG. 3B, on the fastener 104) facilitates mechanical coupling of the viewing aid 102 to the visual content source by gripping a surface of the visual content source.

FIGS. 3A-3C also show the curved arm 110 in a stowed position. The curved arm 110 is formed of a curved member (not labeled) that fits snugly against the housing (body portion) 160 of the viewing aid 102. The housing 120 and/or curved plastic label may also include recesses and/or tabs to keep the curved arm 110 from deploying accidentally. In addition, the outer surface of the curved member, which may be made of plastic, may be textured, dimpled, or coated so that the user can grip it easily.

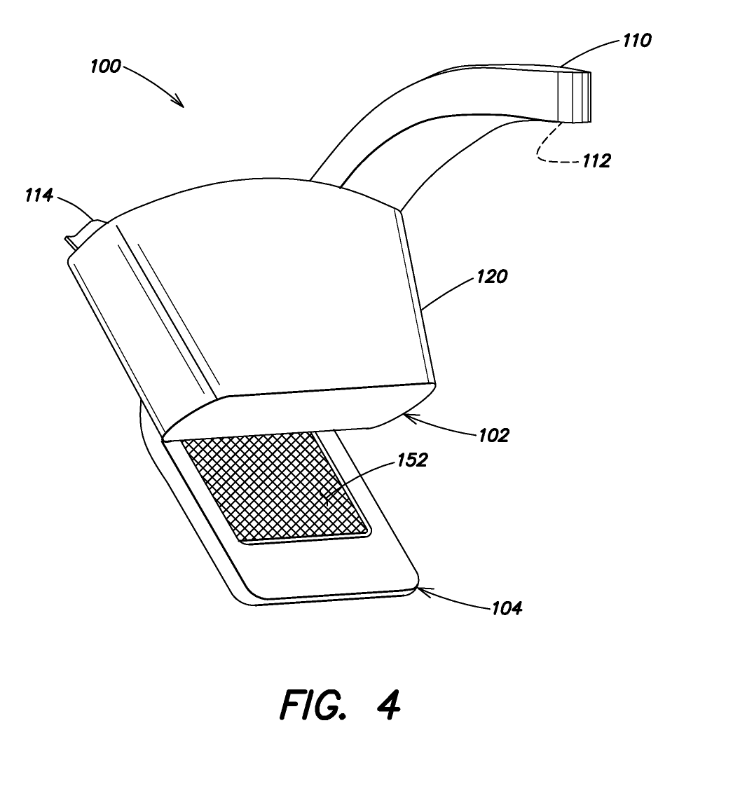

FIG. 4 shows the assembled viewing kit 100 with the viewing arm 110 in a deployed position. To deploy the viewing arm 110, the user gently lifts the viewing arm over a tab 114 that fits inside a recess (not shown) at one end of the viewing arm 110. For simplicity, the recess may be the same recess that holds the light 112 at the end of the viewing arm. The user then pivots the viewing arm 110 to its deployed position about a hinge within the body portion 120 of the viewing aid 102. The hinge may also act as a switch that activates the light 112 once the user rotates the viewing arm 110 through a given angle. An internal cam may limit how far the user can turn the viewing arm 110 to prevent the viewing arm 110 from be accidentally broken.

FIGS. 5A and 5B show a disassembled viewing aid 102. The housing 120 splits into two pieces: a lower half 522 that contains a battery 526, circuitry 540, and a hinge 530, and an upper half 524 that snaps or screws onto the lower half 522. In this case, the viewing arm 110 includes a male hinge part 531 that fits into the hinge 530. When the viewing aid 102 is fully assembled, a cam 532 or stop on the male hinge part 531 hits interior surfaces of the housing 120 when the viewing arm 102 is rotated too far, thereby limiting the rotation range of the viewing arm 102. In other embodiments, the viewing arm 110 may include a female hinge part instead of a male hinge part, and the cam 532 may be disposed on the hinge 530 instead of on the viewing arm 110.

As described above, the battery 526, which may be rechargeable (e.g., via a USB interface), powers a light disposed within one end of the viewing arm 110. The circuitry 540 conditions the power from the battery 526 to drive the light 112, which may be a light-emitting diode, at the appropriate voltage and current. The circuitry 540, (optionally) in connection with the hinge 530, may activate and deactivate the light based on the angle of the viewing arm 110 with respect to the housing 120.

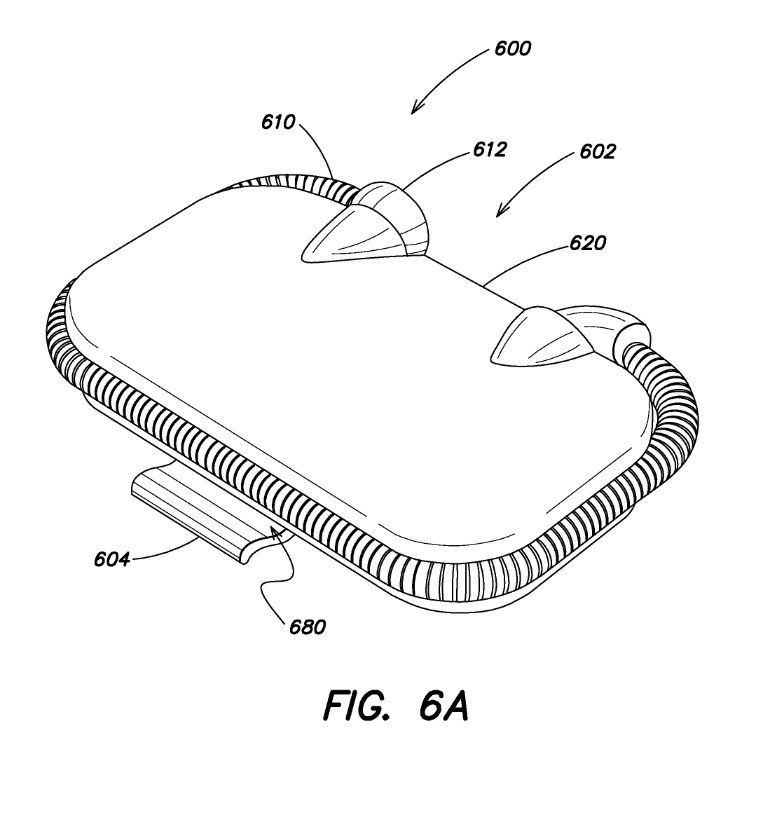

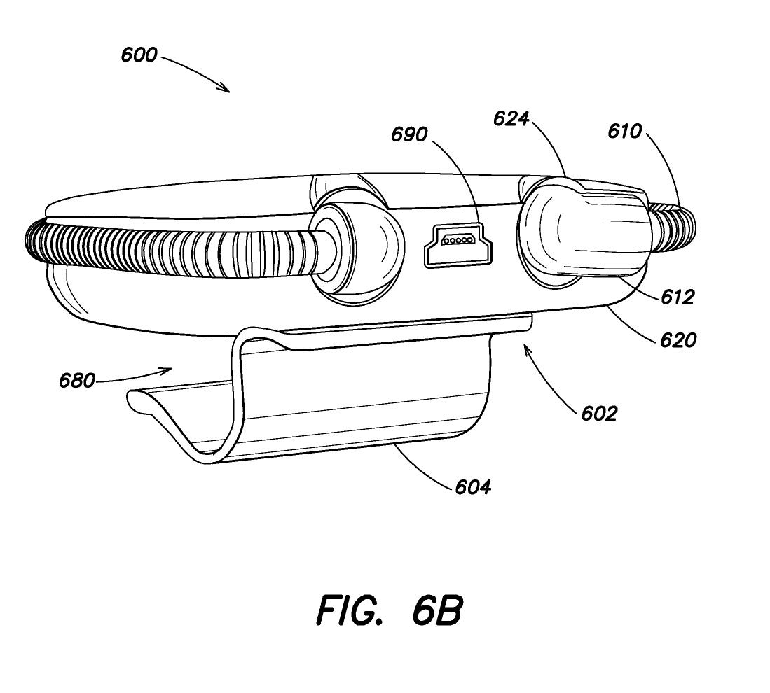

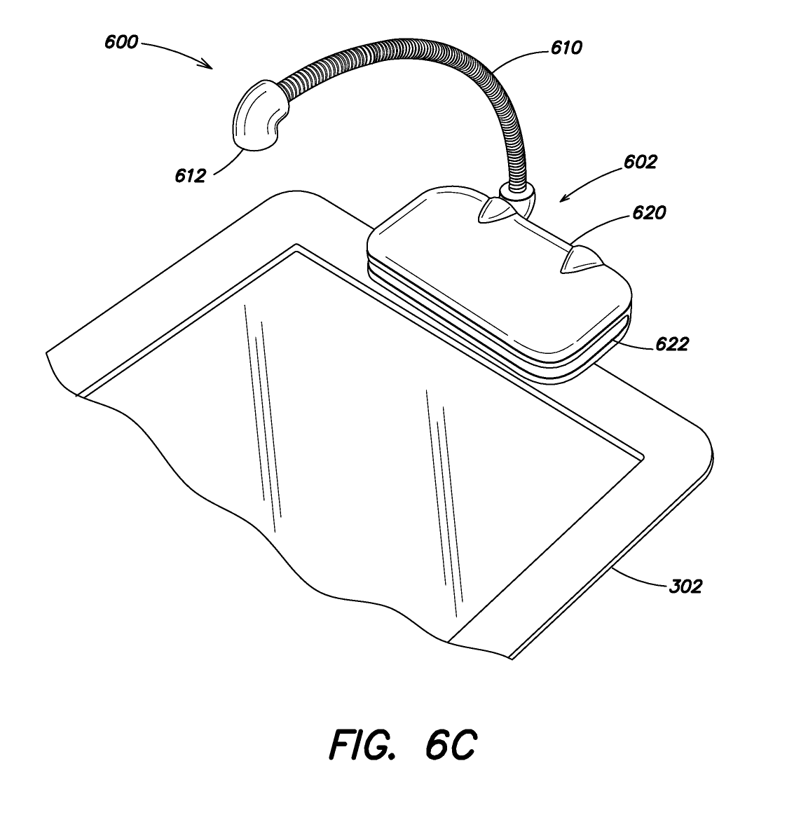

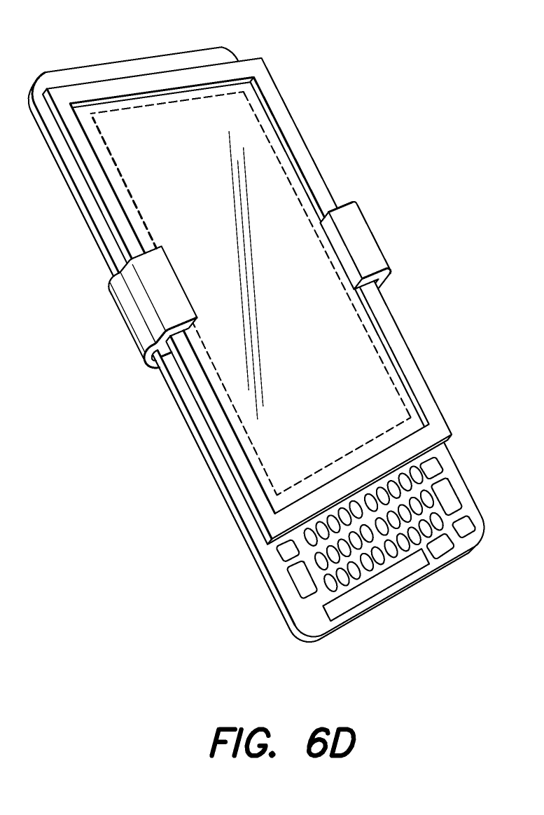

FIGS. 6A-6C show an alternative assembled viewing kit 600 in stowed (wrapped) and deployed positions. The viewing kit includes an alternative viewing aid 602 that can be mechanically coupled and decoupled to a fastener 604 that may be identical to or interchangeable with the fastener 104 of FIGS. 1A-1D and the fastener 264 of FIG. 2C. A cavity 680 formed between the assembled viewing aid 602 and fastener 604 receives a substrate (e.g., e-reader 302) to facilitate viewing of visual content via the substrate as described above.

The viewing aid 602 includes an flexible (articulated) arm 610 that, when stowed, is wrapped around a body portion (housing) 620 of the viewing aid 602. As shown more clearly in FIG. 6C, the stowed arm 610 fits snugly in a recess 622 disposed along at least part of the perimeter of the body portion 620. A light 612 at one end of the arm 610 fits into another recess 624 in the body portion 620. The arm 610 is deployed by unwrapping. When the arm is deployed (FIG. 6B), the user can manipulate the arm 610, which may be articulated, to position the light 612 such that it facilitates optimal viewing of visual content displayed via a substrate (e.g., e-reader 302). The light 612 is activated by a switch (not shown) and powered by a battery (not shown) within the body portion 620. The battery can be recharged using a USB interface 690.

Systems and assemblies that include viewing aids able to removably couple to one or more fasteners may be used and created in any suitable manner. Described below are some exemplary techniques for using and creating systems and assemblies that include viewing aids able to removably couple to one or more fasteners. It should be appreciated, though, that embodiments are not limited to implementing any of the techniques described below.

FIG. 6D is a perspective view of viewing aid and one or more fasteners, according to another embodiment of the present invention. As discussed above, in addition to lighting devices, examples of viewing aids include, but are not limited to, magnifying lenses, prescription lenses, and filters, as well as additional, alternative and/or complimentary sources of visual content. In FIG. 6D, the alternative viewing aid illustrated is coupled to the underlying visual content source so as to substantially cover (e.g., in a parallel plane) a display of the visual content source. It should be appreciated that, in other embodiments, alternative viewing aids according to various embodiments of the present invention need not cover an entire or substantial portion of a display of a visual content source, nor do they need to be substantially parallel to a plane of the display (although in some implementations such a positioning may be advantageous or desirable).

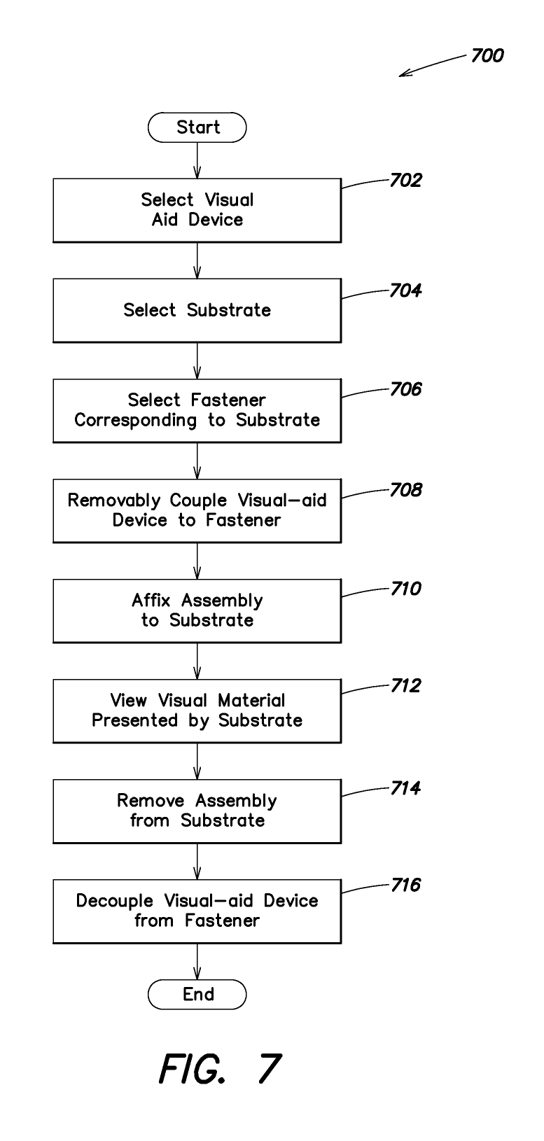

FIG. 7 shows a flowchart of one technique for using a viewing aid and a fastener. The process 700 of FIG. 7 begins in block 702, in which a viewing aid is selected from a set of one or more viewing aids. In block 704, a substrate that is a source of visual information is selected. A user may intend to use the viewing aid in connection with the substrate to facilitate viewing the visual information presented by the substrate.

In block 706, a fastener, corresponding to the substrate selected in block 704, is selected. The fastener may have dimensions corresponding to dimensions of an edge of the substrate and is adapted to affix to the edge of the substrate. The fastener may be customized to affix to the substrate selected in block 704 and/or one or more other substrates.

The viewing aid selected in block 702 and the fastener selected in block 706 each include a part of a complementary interface. In block 708, the parts of the complementary interface, included in the viewing aid and the fastener, are engaged to removably couple the viewing aid to the fastener to form an assembly.

In block 710, the assembly including the viewing aid and the fastener is affixed to the edge of the substrate in any suitable manner. The visual information presented by the substrate is then viewed in block 712, and the viewing aid of the assembly is used to facilitate the viewing.

In block 714, the assembly is removed from the substrate. In block 716, the viewing aid is decoupled from the fastener by disengaging the parts of the complementary interface of the viewing aid and the fastener. The process 700 then ends.

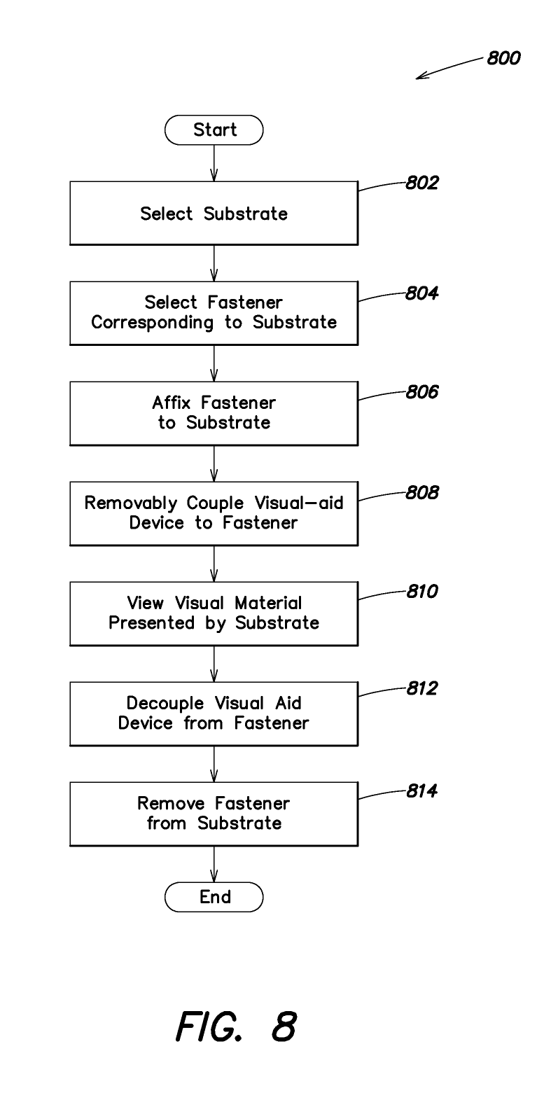

FIG. 8 shows a flowchart of another technique for using a viewing aid and a fastener. The process 800 of FIG. 8 begins in block 802, in which a particular substrate that is a source of visual information is selected. In block 804, a fastener, corresponding to the substrate selected in block 802, is selected. The fastener may have dimensions corresponding to dimensions of an edge of the substrate and is adapted to affix to the edge of the substrate. The fastener may be customized to affix to the substrate selected in block 802 and/or one or more other substrates.

In block 806, the fastener is affixed to the edge of the substrate in any suitable manner.

In block 808, a viewing aid is selected and is removably coupled to the fastener selected in block 804 to form an assembly. The viewing aid and the fastener each include a part of a complementary interface. The viewing aid and the fastener may be removably coupled in block 808 by engaging the parts of the complementary interface.

The visual information presented by the substrate is then viewed in block 810, and the viewing aid of the assembly is used to facilitate the viewing. In block 812, the viewing aid is decoupled from the fastener by disengaging the parts of the complementary interface of the viewing aid and the fastener. In block 814, the fastener is removed from the substrate. The process 800 then ends.

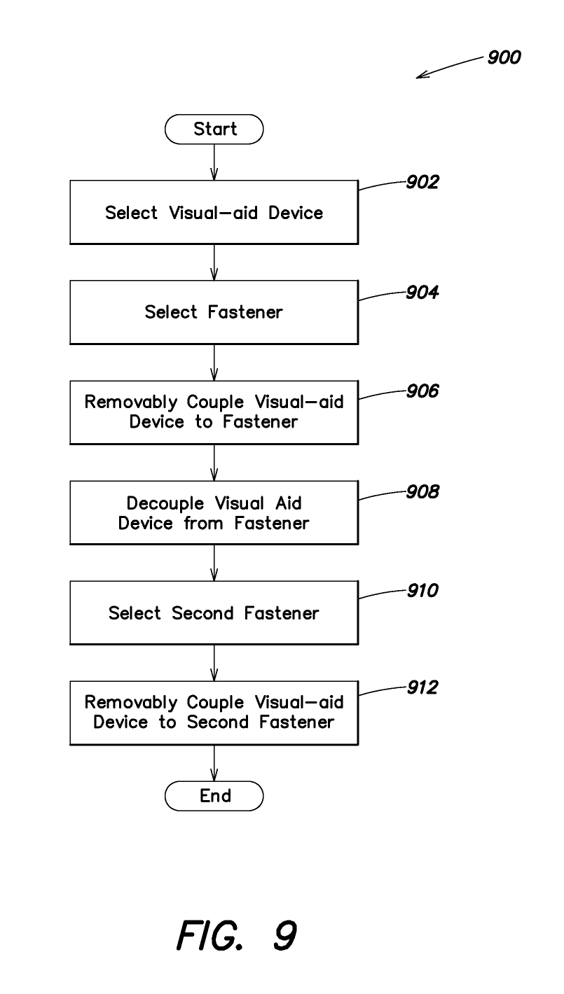

FIG. 9 shows a flowchart of another technique for using a viewing aid and a set of two or more fasteners. Process 900 of FIG. 9 begins in block 902, in which a viewing aid having a first interface that is a part of a complementary interface is selected. In block 904, a fastener having a second interface that is a part of the complementary interface is selected. The fastener selected in block 904 may have dimensions corresponding to dimensions of an edge of a particular substrate with which a user desires to use the viewing aid.

In block 906, the first interface of the viewing aid and the second interface of the fastener are engaged, such that the viewing aid is removably coupled to the fastener. The viewing aid and the fastener can then be used together as an assembly and, for example, affixed to the particular substrate to which the fastener corresponds and used to facilitate viewing of visual information presented by the particular substrate.

In block 908, the viewing aid is decoupled from the fastener by disengaging the first interface and the second interface.

In block 910, a second fastener is selected that has the second interface that is a part of the complementary interface. The second fastener selected in block 910 may have dimensions corresponding to dimensions of an edge of a second particular substrate with which a user desires to use the viewing aid. The second particular substrate and the first particular substrate may have different dimensions and/or may present different visual information.

In block 912, the first interface of the viewing aid and the second interface of the second fastener are engaged, such that the viewing aid is removably coupled to the second fastener. The viewing aid and the second fastener can then be used together as an assembly and, for example, affixed to the second particular substrate to the which the second fastener corresponds and used to facilitate viewing of visual information presented by the second particular substrate. The process 900 then ends.

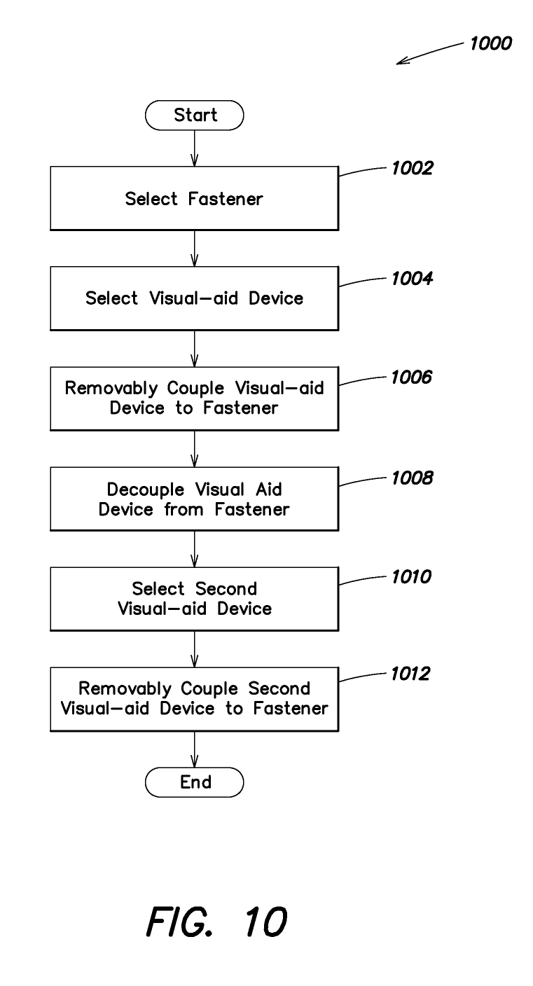

FIG. 10 shows an example of another technique for using a viewing aid and a set of two or more fasteners. Process 1000 begins in block 1002, in which a fastener having a second interface that is a part of a complementary interface is selected. The fastener selected in block 1002 may have dimensions corresponding to dimensions of an edge of a particular substrate.

In block 1004, a viewing aid having a first interface that is a part of a complementary interface is selected. The viewing aid may perform a first function to facilitate viewing of visual information provided by the particular substrate to which the fastener corresponds. For example, the viewing aid may be a lighting device that illuminates the particular substrate to facilitate viewing the visual information.

In block 1006, the first interface of the viewing aid and the second interface of the fastener are engaged, such that the viewing aid is removably coupled to the fastener. The viewing aid and the fastener can then be used together as an assembly and, for example, affixed to the particular substrate to which the fastener corresponds and used to facilitate viewing of visual information presented by the particular substrate.

In block 1008, the viewing aid is decoupled from the fastener by disengaging the first interface and the second interface.

In block 1010, a second viewing aid having a first interface that is a part of a complementary interface is selected. The second viewing aid may perform a second function to facilitate viewing of visual information provided by the particular substrate to which the fastener corresponds. For example, the second viewing aid may be a magnifying device that magnifies all or a portion of the visual information presented by the particular substrate to facilitate viewing the visual information.

In block 1012, the first interface of the second viewing aid and the second interface of the fastener are engaged, such that the second viewing aid is removably coupled to the fastener. The second viewing aid and the fastener can then be used together as an assembly and, for example, affixed to the particular substrate to which the fastener corresponds and used to facilitate viewing of visual information presented by the particular substrate. The process 1000 then ends.

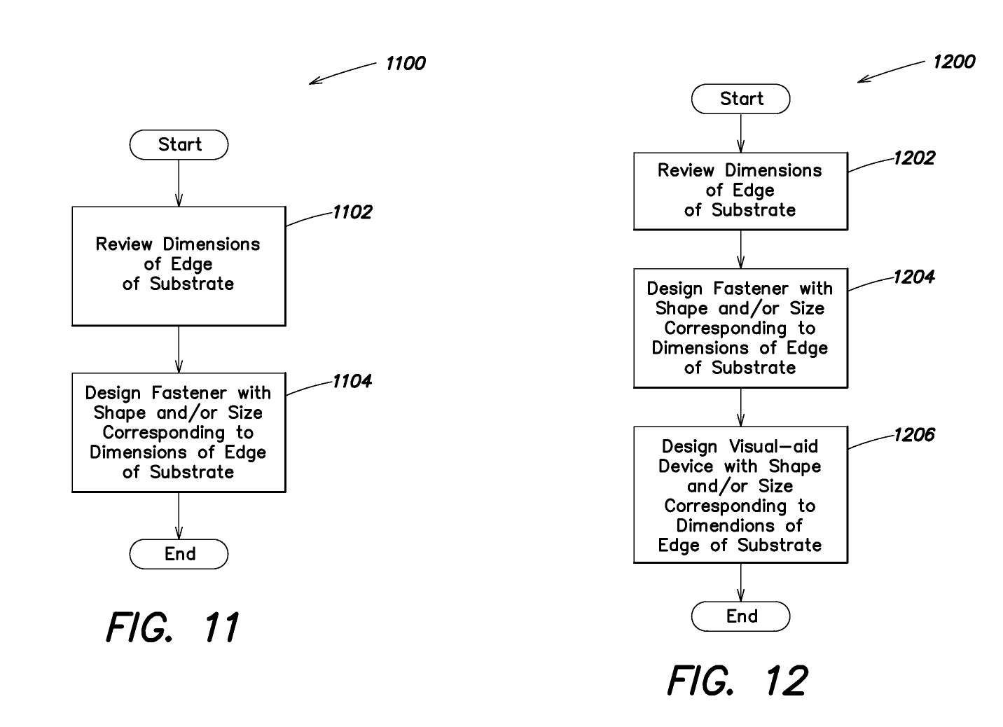

FIG. 11 shows a flowchart of one technique for making a fastener having dimensions that correspond to dimensions of an edge of a particular substrate, such that the fastener may be affixed to the edge of the particular substrate. The process 1100 begins in block 1102, in which dimensions of the edge of the particular substrate are reviewed. Reviewing the dimensions of the edge may include reviewing any suitable dimensions, including a shape and/or a size of the edge. For example, a thickness of the edge at one or more points may be reviewed. As another example, a shape of one or more curves of the edge may be reviewed. Additionally, in some implementations, reviewing dimensions of the edge may include reviewing dimensions of one or more faces of the substrate that meet at the edge. For example, a width of a frame or bezel of face of a particular substrate may be reviewed. As another example, a shape of face of the particular substrate may be reviewed.

In block 1104, a fastener having a shape and/or size corresponding to the dimensions of the edge is designed. The fastener may include a curve and/or one or more members that have a shape and/or size equal or approximately equal to the dimensions of the edge. For example, a size of a fastener may be such that when the fastener is affixed to the particular substrate, no portion of the fastener obstructs a view of visual information presented by the substrate. For example, where the substrate includes a bezel or frame, the fastener may have a size such that when the fastener is affixed to the substrate, no portion of the fastener extends beyond the bezel. In some implementations, an inner dimension of a curve of the fastener may be designed to substantially correspond to an outer dimension of the edge of the particular substrate. The fastener may be designed in block 1104 in any suitable manner having any dimensions corresponding to dimensions of the edge.

Once the fastener is designed in block 1104, the process 1100 ends.

FIG. 12 shows a flowchart of one technique for making a fastener having dimensions that correspond to dimensions of an edge of a particular substrate, such that the fastener may be affixed to the edge of the particular substrate. Process 1200 begins in block 1202, in which dimensions of the edge of the particular substrate are reviewed. As discussed above in connection with FIG. 11, any suitable dimensions of an edge may be reviewed, including a shape and/or size of an edge and/or faces of the substrate meeting at the edge.

In block 1204, a fastener having a shape and/or size corresponding to dimensions of the edge is designed. As discussed above in connection with FIG. 11, the fastener may be designed in any suitable manner to have dimensions corresponding to dimensions of the edge. For example, an inner dimension of a curve of the fastener may be designed to substantially correspond to an outer dimension of the edge of the particular substrate.

In block 1206, a viewing aid is designed with a housing having a shape and/or size corresponding to dimensions of the edge of the substrate. The viewing aid may be designed with a face of a housing that will contact the substrate, when the viewing aid is affixed to the substrate, having the dimensions corresponding to the edge of the substrate. As discussed above in connection with designing a fastener having dimensions corresponding to dimensions of the edge, the viewing aid may be designed in any suitable manner to have dimensions corresponding to dimensions of the edge. For example, a size of a viewing aid may be such that when the viewing aid is affixed to the particular substrate, no portion of the viewing aid obstructs a view of visual information presented by the substrate. For example, where the substrate includes a bezel or frame, the viewing aid may have a size such that when the viewing aid is affixed to the substrate, no portion of the viewing aid extends beyond the bezel.

Once the viewing aid is designed in block 1206, the process 1200 ends.

It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

As discussed above, the inventive concepts are not mutually exclusive, and implementations may be employed which incorporate any suitable combination of two or more of the inventive concepts. Further, it should be appreciated that each of the techniques, principles, aspects, and embodiments described above and shown in the attached figures is an inventive concept alone or in combination with other inventive concepts.

1. A kit, comprising:
a viewing aid to facilitate viewing of visual content displayed by a visual content source; and
a fastener,
wherein:
at least one of the viewing aid and the fastener includes a coupling interface to facilitate mechanical coupling and decoupling of the fastener and the viewing aid; and
the fastener, or an assembly comprising the viewing aid and the fastener when coupled, form a cavity to facilitate a mechanical coupling of the viewing aid to the visual content source.

2. The kit of claim 1, wherein the fastener forms the cavity to facilitate the mechanical coupling of the viewing aid to the visual content source.

3. The kit of claim 1, wherein the assembly comprising the viewing aid and the fastener forms the cavity to facilitate the mechanical coupling of the viewing aid to the visual content source.

4. The kit of claim 1, wherein the cavity is a deformable cavity to facilitate a pressure-fit coupling, via a pinching force, of the viewing aid to the visual content source.

5. The kit of claim 4, further comprising the visual content source.

6. The kit of claim 5, wherein:
the visual content source is an e-reader; and
the visual aid is a lighting device.

7. The kit of claim 1, wherein the viewing aid comprises at least one of:
a lighting device;
a filter;
a magnifying lens; and
a prescription lens.

8. The kit of claim 1, wherein the fastener is at least partially formed of a resilient material that deforms upon insertion of the visual content source into the deformable cavity.

9. The kit of claim 8, wherein, when deformed by insertion of the visual content source into the deformable cavity, the fastener exerts a normal force on the visual content source.

10. The kit of claim 1, wherein at least one of the viewing aid and the fastener includes a pad to facilitate the mechanical coupling of the viewing aid to the visual content source.

11. The kit of claim 10, wherein:
the assembly comprising the viewing aid and the fastener forms the cavity; and
when the viewing aid is coupled to the fastener, the pad is disposed along an inner surface of the cavity so as to facilitate the mechanical coupling of the viewing aid to the visual content source.

12. The kit of claim 1, wherein:
the viewing aid comprises:
a body portion; and
a first coupling interface formed on, or attached to, the body portion; and the fastener comprises:
a second coupling interface to mechanically couple to the first coupling interface of the viewing aid so as to facilitate mechanical coupling and decoupling of the fastener and the viewing aid.

13. The kit of claim 12, wherein the first and second coupling interfaces include complimentary mating interfaces.

14. The kit of claim 12, wherein
the first coupling interface includes one of a slot and a projecting member that fits into the slot; and
the second coupling interface includes the other of the slot and the projecting member.

15. The kit of claim 14, wherein one of the slot and the projecting member includes a locking tab to facilitate locking engagement between the slot and the projecting member.

16. The kit of claim 15, wherein the other of the slot and the projecting member includes a depression to receive the locking tab.

17. The kit of claim 12, wherein:
the first coupling interface includes a projecting member formed on or attached to the body portion of the viewing aid;
the second coupling interface includes a slot in at least a portion of the fastener configured to receive the projecting member; and
the second coupling interface is formed of a resilient material that deforms upon insertion of the projecting member into the slot, such that the second coupling interface exerts a pinching force on the projecting member to facilitate mechanical coupling of the fastener and the viewing aid.

18. The kit of claim 17, wherein the projecting member includes at least one locking tab to facilitate locking engagement between the slot and the projecting member.

19. The kit of claim 18, wherein the slot includes at least one depression to receive the at least one locking tab.

20. The kit of claim 1, wherein the viewing aid includes a lighting device, and wherein the lighting device comprises:
an arm coupled to the body portion; and
at least one light source disposed in or on the arm,
wherein:
the arm is movable with respect to the body portion between a stowed position substantially adjacent to the body portion and at least one deployed position; and
the at least one light source is activated to generate light when the arm is moved to the at least one deployed position.

21. The kit of claim 20, wherein the arm of the lighting device comprises:
a curved member including:
a proximal end rotatably coupled to the body portion of the lighting device; and
a distal end in or on which the at least one light source is disposed,
wherein the curved member is configured to rotate from the stowed position to the at least one deployed position.

22. The kit of claim 21, wherein the lighting device further includes a cam to limit a rotation range of the arm.

23. The kit of claim 20, wherein:
the arm of the lighting device comprises a flexible member; and
when in the stowed position, the flexible member is wrapped around at least a portion of a perimeter of the body portion of the lighting device.

24. A kit, comprising:
A) a booklight to facilitate viewing of visual content displayed by multiple different types of e-readers, the booklight comprising:
A1) a body portion;
A2) an arm rotatably coupled to the body portion, the arm including at least one light source; and
A3) a first interface to facilitate mechanical coupling of the booklight to one of a plurality of different interchangeable fasteners;
B) a first fastener having a second interface to mechanically couple to the first interface of the booklight so as to facilitate mechanical coupling and decoupling of the first fastener and the booklight, such that the first fastener, or a first assembly of the booklight and the first fastener when mechanically coupled, forms a first deformable cavity to facilitate a first pressure-fit coupling, via a first pinching force, of the booklight and the first fastener to a first edge of a first e-reader, the first edge having a first physical characteristic; and
C) a second fastener having a third interface to mechanically couple to the first interface of the booklight so as to facilitate mechanical coupling and decoupling of the second fastener and the booklight, such that the second fastener, or a second assembly of the booklight and the second fastener when mechanically coupled, forms a second deformable cavity to facilitate a second pressure-fit coupling, via a second pinching force, of the booklight and the second fastener to a second edge of a second e-reader, the second edge having a second physical characteristic,
wherein:
the first physical characteristic of the first edge of the first e-reader is different than the second physical characteristic of the second edge of the second e-reader;
at least one characteristic of the first deformable cavity is based at least in part on the first physical characteristic of the first edge of the first e-reader; and
at least one characteristic of the second deformable cavity is based at least in part on the second physical characteristic of the second edge of the second e-reader.

25. The kit of claim 24, wherein:
the first physical characteristic of the first edge of the first e-reader includes a first shape of the first edge;
the second physical characteristic of the second edge of the second e-reader includes a second shape of the second edge; and
the first shape is different than the second shape.

26. The kit of claim 24, wherein:
the first physical characteristic of the first edge of the first e-reader includes a first dimension of the first edge representing a first thickness of the e-reader;
the second physical characteristic of the second edge of the second e-reader includes a second dimension of the second edge representing a second thickness of the e-reader; and
the first thickness is different than the second thickness.

27. A booklight to facilitate viewing of visual content displayed by multiple different types of e-readers, the book light comprising:
a body portion;
an arm coupled to the body portion, the arm including at least one light source; and
a coupling interface to facilitate mechanical coupling and decoupling of the booklight to one fastener of a plurality of different interchangeable fasteners.

28. The booklight of claim 27, wherein:
the arm is movable with respect to the body portion between a stowed position substantially adjacent to the body portion and at least one deployed position.

29. The booklight of claim 28, further including:
a power source disposed within the body portion; and
a switch disposed within the body portion, coupled to the power source, and configured to supply power to the at least one light source when the arm is moved to the at least one deployed position.

30. The booklight of claim 28, wherein the power source includes at least one rechargeable battery, and wherein the booklight further comprises:
a power interface disposed on the body portion or the coupling interface to receive external power to recharge the at least one rechargeable battery.

31. The booklight of claim 28, wherein the arm comprises:
a curved member including:
a proximal end rotatably coupled to the body portion; and
a distal end in or on which the at least one light source is disposed,
wherein the curved member is configured to rotate from the stowed position to the deployed position.

32. The booklight of claim 31, further comprising a cam to limit a rotation range of the arm.

33. The booklight of claim 28, wherein:
the arm comprises a flexible member; and
when in the stowed position, the flexible member is wrapped around at least a portion of a perimeter of the body portion.

34. The booklight of claim 27, wherein the one fastener, or an assembly comprising the booklight and the one fastener when coupled, forms a deformable cavity to facilitate a pressure-fit coupling, via a pinching force, of the booklight and the one fastener to an edge of an e-reader.

35. The booklight of claim 34, further comprising a pad disposed on the body portion, wherein:
the assembly comprising the booklight and the one fastener when coupled forms the deformable cavity; and
when the booklight is coupled to the one fastener, the pad is disposed along an inner surface of the deformable cavity.

36. The booklight of claim 34, in combination with the one fastener.

37. An apparatus, comprising:
a booklight to facilitate viewing of visual content displayed by an e-reader, the book light comprising:
a body portion;
an arm coupled to the body portion, the arm including at least one light source; and
a first coupling interface; and
a fastener having a second coupling interface removably coupled to the first coupling interface of the booklight,
wherein the fastener, or an assembly comprising the booklight and the fastener, forms a deformable cavity to facilitate a pressure-fit coupling, via a pinching force, of the booklight and the fastener to an edge of the e-reader.

38. The apparatus of claim 37, further comprising the e-reader, wherein the booklight and the fastener are pressure-fit coupled to the e-reader via the pinching force.

39. A method of facilitating viewing of visual content displayed via a visual content source, the method comprising:
A) mechanically engaging a first coupling interface of a viewing aid to a second coupling interface of a fastener, wherein the fastener, or an assembly comprising the viewing aid and the fastener when coupled, forms a cavity;
B) inserting the visual content source at least partially into the cavity; and
C) positioning the viewing aid to facilitate viewing of at least some of the visual content.

40. The method of claim 39, wherein the viewing aid includes an arm having at least one light source, and wherein C) comprises:
C1) moving the arm from a stowed position to at least one deployed position in which the at least one light source illuminates at least part of the visual content.

41. The method of claim 40, wherein C1) comprises:
rotating the arm from the stowed position to the at least one deployed position.

42. The method of claim 40, wherein the arm includes a flexible member, and wherein C1) comprises:
unwrapping the flexible member from around a housing of the viewing aid.
